(19) United States
(12) Patent Application Publication
(10) Pub. No.: US 2005/0248822 A1
(43) Pub. Date: Nov. 10, 2005

(54) Optical transmission/reception module

(76) Inventors: Hitomaro Tohgoh, Kanagawa (JP); Hiroaki Asano, Kanagawa (JP); Hitoshi Uno, Kanagawa (JP); Masaki Kobayashi, Kanagawa (JP); Nobutaka Itabashi, Kanagawa (JP); Nobuyuki Akiya, Kanagawa (JP)

Correspondence Address: CONNOLLY BOVE LODGE & HUTZ LLP, SUITE 800, 1990 M STREET NW, WASHINGTON, DC, 20036-3425, US

(21) Appl. No.: 10/525,507

(22) PCT Filed: Aug. 26, 2003
(86) PCT No.: PCT/JP03/10770

§ 371 Date: Apr. 20, 2005

(30) Foreign Application Priority Data
Aug. 26, 2002 (JP) 2002-244719

(51) Int. Cl. G03H 1/00

(52) U.S. Cl. 359/31

(57) ABSTRACT

A small-sized optical transceiver module, wherein any stress attributable to the differences in coefficient of thermal expansion between a transmission section optical system, a receiving section optical system, and the components which integrate and fix them and the like is not applied therebetween, and which is not influenced by any stress at the time of attachment/detachment of the optical connector is disclosed. The optical transceiver module is one wherein the transmission section optical system 1 which comprises a laser diode and an optical fiber or an optical waveguide optically connected to the laser diode and of which the electric input terminal of the laser diode is a flexible cable, a receiving section optical system 2 which comprises a photo diode and an optical fiber or an optical waveguide optically connected to the photo diode and of which the electric output terminal of the photo diode is a flexible cable, and an optical I/O optical receptacle 3 are optically connected, mechanically integrated and fixed, and the two flexible cables are spatially spaced out and disposed.

### TECHNICAL FIELD

The present invention relates to an optical transceiver module used for optical fiber communication and the like.

### BACKGROUND ART

Optical fiber communication which can transmit large volumes of information at a high-speed with low-loss in place of a metallic cable is drawing attention, and in recent years, high functionality, together with the price-reduction and speed-acceleration of an optical device, has become increasingly required. Although, as one example, the development of an optical communications system which realizes an up-and-down optical bidirectional transmission in different wavelengths using one optical fiber has been advanced, the optical module in this optical communications system requires a technology that integrates a laser diode, a photo diode, a wavelength division, a multiplexing functional part, and the like.

Described below are two typically conventional optical transceiver modules. FIG. 6 is a first configuration example of a conventional optical transceiver module, which utilizes a laser diode and a photo diode in a can package. In the same figure, an optical transceiver module 60 is constructed so that a WDM (wavelength division multiplexing) filter 61 is inserted into an optical system optical path which comprises a lens 64, in order to separate a receiving wavelength λ1 signal from a transmission wavelength λ2 signal. After the received light of wavelength λ1 is reflected by the WDM filter 61, the light is received in a lens-mounted PD (photo diode) can 63 within the can package, and after the transmitted light of wavelength λ2 from a lens-mounted LD (laser diode) can 62 passes through the WDM filter 61, the light is condensed into an optical fiber 65. These entire modules are covered with metallic cubicle 66, and the electric signal I/O lead wires in the can package of each of the lens-mounted LD can 62 and the lens-mounted PD can 63 are fixed on a circuit substrate 87 by soldering.

Described next is a second construction example of the conventional optical transceiver module wherein the photo diode and the laser diode of bare chips are integrated in one package. The optical transceiver module 70 shown in FIG. 7A is disclosed in the Japanese Patent Laid-Open Publication No. 11-68705 and is the WDM optical transceiver module utilizing an optical waveguide. In the optical transceiver module 70, a Y-shaped optical waveguide 72 is formed on the Si substrate 73. An optical fiber 71 is connected to one end of the optical waveguide 72, a laser diode 75 and a monitoring photo diode 74 are connected to another end, and a photo diode 76 is connected to the remaining end. Here, the monitoring photo diode 74, the laser diode 75, and the photo diode 76 are mounted on the optical waveguide 72 after high-precision two-dimensional adjustment has been performed on each diode so as to allow the incident/outgoing lights to be optically connected. The positioning of the laser diode 75 and the photo diode 76 is performed by using an alignment marker 78 accurately preformed on the Si substrate 73.

After the outputted light of wavelength λ2 of the laser diode 75 is reflected by a WDM filter 77 allocated to the intermediate section of the Y-shaped optical waveguide 72, this light is introduced to the optical fiber 71 through the optical waveguide 72. Here, the core of the optical fiber 71 and the optical waveguide 72 are allocated so as to enable optical connection. A common allocation method is one wherein a V-shaped groove is accurately processed on the Si substrate 73, relative to the position of the optical waveguide 72, and the optical fiber 71 is fixed along this V-shaped groove. On the other hand, the optical signal of wavelength λ1 transmitted from the optical fiber 71 permeates the WDM filter 77 and is received by the photo diode 76. The laser diode 76 has a structure wherein an incident light can be received from the lateral direction of the chip.

The optical transceiver module 70 shown here is mounted on a circuit substrate 81 by soldering, as shown in FIG. 7B. When attaching/detaching the optical connector/adaptor 79 on the user side, since strong stress is applied, it is common practice to connect the optical connector/adaptor 79 to the optical transceiver module 70 through the optical fiber cord 80 rather than directly connect the optical connector/adaptor 79 to the optical transceiver module 70.

Out of the afore-mentioned conventional devices, since, in the optical transceiver module 60 shown in FIG. 6, the photo diode and the laser diode are each constructed in a separate can package, there is an advantage in that the influence of the electric cross talk is small. However, miniaturization was difficult because the optical axis adjustment is complicated and the rigid metallic cubicle 66 which retains the lens optical system is required. In addition, since the optical transceiver module 60 and the circuit substrate 67 is wired through the lead wires, a pigtail optical fiber was required so as not to receive any external stress when attaching/detaching the optical connector.

On the other hand, in the optical transceiver module 70 shown in FIGS. 7A and 7B, miniaturization can be realized by mounting the laser diode 75 and the photo diode 76 on the single Si substrate 73 where the optical waveguide 72 is formed. However, since high-precision processing of the V-shaped groove and the optical waveguide 72 is required, the components are expensive, and at the same time, because the laser diode 75 and the photo diode 76 are allocated in proximity to each other, the electric and optical cross talks were large, and thus, acceleration was difficult. In addition, since direct stress is applied to the lead section of the package when attaching/detaching the optical connector/adaptor 79, it was difficult to directly connect the lead section to the optical connector/adaptor 79 used by the general user, and the optical fiber cord 80 connecting the optical connector/adaptor 79 and the optical transceiver module 70 was required.

### DISCLOSURE OF THE INVENTION

The present invention was made to solve the foregoing problems of the conventional device and its objective is to provide a small-sized optical transceiver module wherein any stress attributable to the differences in coefficients of thermal expansion between the transmission section optical system, the receiving section optical system and the components which integrate and fix these systems and the like is not applied therebetween, and any stress is not influenced thereon at the time of the attachment/detachment of the optical connector.

Another purpose of the present invention is to provide an optical transceiver module wherein the electric cross talk and the optical cross talk are small and acceleration is possible.

Another purpose of the present invention is to provide an optical transceiver module capable of realizing the large-scale integration of the optical transmission device by increasing the mounting density.

The invention of claim 1 is an optical transceiver module wherein a transmission section optical system which comprises a laser diode and an optical fiber or an optical waveguide optically connected to the laser diode and wherein the electric input terminal of the laser diode is a flexible cable, a receiving section optical system which comprises a photo diode and an optical fiber or an optical waveguide optically connected to the photo diode and wherein the electric input terminal of the photo diode is a flexible cable, and an optical I/O optical receptacle are optically connected and are mechanically integrated and fixed, and the two flexible cables are spatially separated and disposed.

This construction enables realization of a small receptacle-structured optical transceiver module wherein any stress attributable to the differences in the coefficient of thermal expansion between the transmission section optical system, the receiving section optical system and the components which integrate and fix these systems or the like is not applied therebetween and any stress is not influenced thereon at the time of the attachment/detachment of the optical connector.

The invention of claim 2 is an optical transceiver module according to claim 1, wherein the transmission section optical system, the receiving section optical system, and the optical I/O optical receptacle are disposed roughly in a straight line.

Since the construction allows the width in the vertical direction to the direction of the optical axis of the optical I/O optical receptacle to be reduced, the mounting density when a plurality of optical transceiver modules is laterally disposed becomes high, and a large-scale integration to the optical transmission device can be realized.

The invention of claim 3 is an optical transceiver module according to claim 2, wherein the receiving section optical system comprises optical fiber which has processed surfaces which transverse the core on a slant in-line in a longitudinal direction and oppose each other, a slanted light outgoing section formed by inserting a filter or a half-mirror between the processed surfaces, and a photo diode which is optically connected to the slanted light outgoing section, the transmission section optical system is connected to one end of the optical fiber, and the optical I/O optical receptacle is connected to the other end of the optical fiber.

This construction allows the module to dispense with the lens optical system and the optical waveguide and allows the module to construct the slanted light outgoing section with a small number of the parts and a small space.

The invention of claim 4 is an optical transceiver module according to claim 3, wherein a photo diode has a back side incidence-type structure where the light is entered from the surface opposite to the electrode surface which has positive and negative electrodes and a photo diode is flip-chipped on the circuit substrate to which a flexible cable is connected.

Since this construction is a construction wherein the electrode surface of the photo diode or the like is covered with resin, the module dispenses with a package which covers the entire receiving section, and therefore, the electric cross talk is small, and acceleration can be realized.

The invention of claim 5 is an optical transceiver module according to claim 1, wherein the transmission section optical system has an airtight can package from which the electric signal input lead wire is led, the electric signal input lead wire and the flexible cable or the electrode surface of the flexible cable with the substrate are disposed in parallel, and the electric signal input lead wire and the flexible cable or the electrode of the flexible cable with the substrate are connected.

This construction allows the module to dispense with the bending process of the lead wire of the laser diode can package, and enables acceleration by minimizing the length of wiring.

The invention of claim 6 is an optical transceiver module according to claim 5, wherein the leading direction of the electric signal input lead wire in the airtight can package and the extension direction of the signal line in the flexible cable are almost vertical.

This construction allows the length of the electric circuit substrate in the direction of the optical axis to be shortened and also allows the directions of the flexible cables of the transmission section optical system and the receiving section optical system to match with each other, and thereby, the attachment/detachment of the optical module is facilitated. In addition, the off-position generated to the rotational direction of the LD can package can be easily absorbed.

The invention of claim 7 is an optical transceiver module with a pig-tail fiber where the transmission section optical system which includes a laser diode and an optical fiber or an optical waveguide optically connected to the laser diode and the receiving section optical system which includes a photo diode and an optical fiber or an optical waveguide optically connected to the photo diode are optically connected, as well as mechanically integrated and fixed, and one of the electric input terminal of the transmission section optical system or the electric output terminal of the receiving section optical system is a flexible cable.

According to this construction, any stress attributable to the difference in coefficient of thermal expansion which was the problem when these systems were fixed to the circuit substrate is not applied thereto, and an optical transceiver module superior in high speed characteristics can be realized.

### BRIEF DESCRIPTION OF THE DRAWINGS

FIG. 1A is a perspective view showing the optical connection condition of the major elements of a construction in a first embodiment of a optical transceiver module according to the present invention; and FIG. 1B is a perspective view of a circuit substrate wherein the major elements shown in FIG. 1A are mechanically fixed;

FIG. 2 is a perspective view showing the connection and fixing conditions of each element shown in FIGS. 1A and 1B;

FIG. 3 is a sectional view showing a detailed construction of the receiving section optical system in the receiving section shown in FIGS. 1A and 1B;

FIG. 4 is a perspective view showing the optical connection condition of the major elements of a construction in a second embodiment of the optical transceiver according to the present invention;

FIG. 5 is a perspective view showing the construction in a third embodiment of the optical transceiver module according to the present invention;

FIG. 6 is a diagram showing a first construction example of a conventional optical transceiver module; and

FIGS. 7A and 7B are diagrams showing the first construction example of a conventional optical transceiver module.

### BEST MODE FOR CARRYING OUT THE INVENTION

Described below in detail is the best mode based on the preferred embodiment modes showing the present invention in the figures.

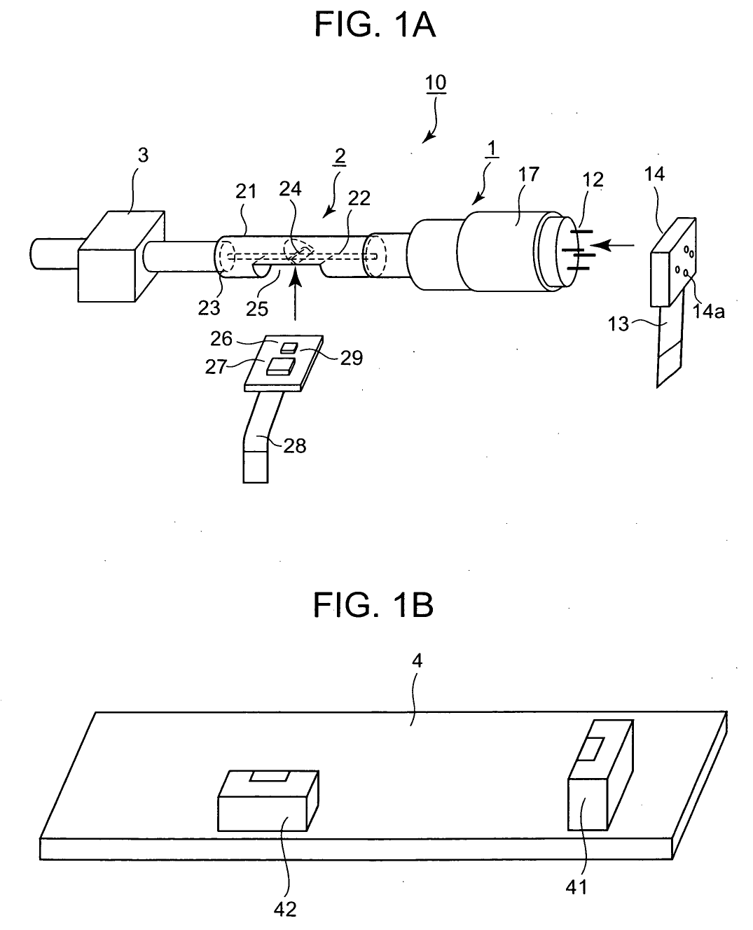

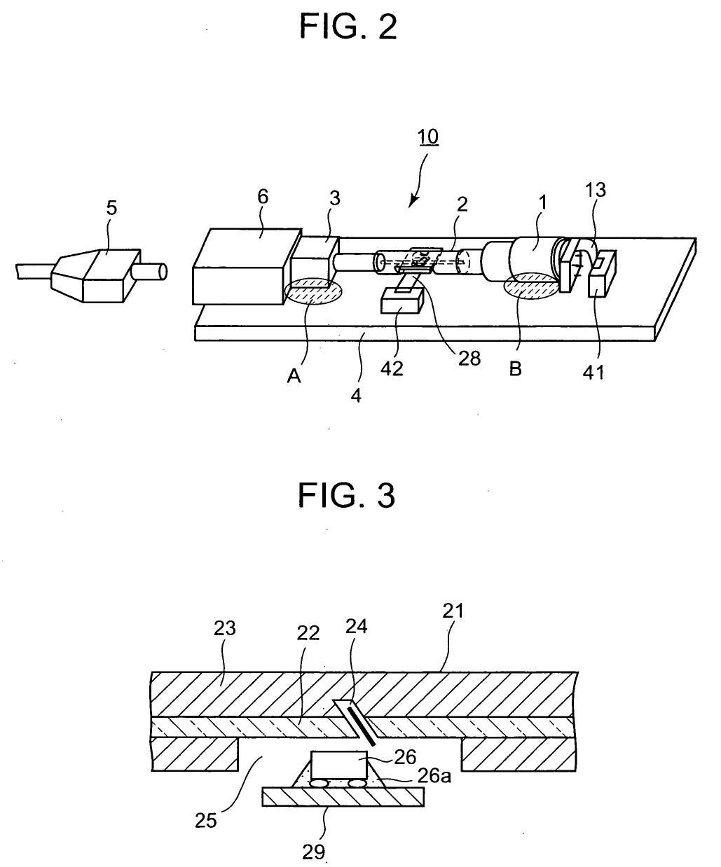

FIG. 1A is a perspective view showing the optical connection condition of the major elements is a first embodiment of a optical transceiver module according to the present invention; FIG. 1B is a perspective view of a circuit substrate wherein the major elements shown in FIG. 1A are mechanically fixed and electrically connected; FIG. 2 is a perspective view showing the connection and fixing conditions of each element shown in FIGS. 1A and 1B; and FIG. 3 is a sectional view showing the detailed construction of the transmission section optical system shown in FIGS. 1A and 1B.

In each of these figures, the optical transceiver module, shown in its entirety in Reference No. 10, comprises a transmission section optical system 1, a receiving section optical system 2, and an optical I/O optical receptacle 3 which are mutually connected optically.

Of them, the transmission section optical system 1 comprises a LD can 11 with a lens which comprises a laser and an optical fiber or an optical waveguide which is optically connected to the laser diode, and a substrate 14 with a LD flexible cable which is fixed by soldering to an electric signal input lead wire 12 led from the LD can 11 and to which an electric signal supply flexible cable 13 is attached. The receiving section optical system 2, as the detail thereof is also shown in FIG. 3, comprises an optical fiber 21, a WDM filter 24 which is mounted on a slant on a core 22 in-line in the longitudinal direction of the optical fiber 21, and a laser diode 26 and a preamplifier 27 which are mounted on a cutout 25 of a ferrule 23 formed at the region on which the WDM filter 24 is mounted. The laser diode 26 and the preamplifier 27 are loaded on a substrate 29 with a flexible cable to which a flexible cable 28 is attached, and these elements are integrally mounted on the cutout 25 of the ferrule 23.

In addition, a through hole 14a is provided beforehand on the substrate 14 with the LD flexible cable which is fixed to the electric signal input lead wire 12 of the LD can 11, and the electric signal input lead wire 12 is inserted into the through hole 14a and soldered, and thereby, the substrate 14 with the LD flexible cable is vertically fixed to the electric signal input lead wire 12.

On the other hand, in order to mount the WDM filter 24 on a slant on the core 22, as shown in FIG. 3, for example, a slit is formed diagonally by the blade of a dicing saw, the WDM filter 24 is inserted thereinto and fixed at the intermediate section in the longitudinal direction of the cutout 25 of the ferrule 23, thereby enabling the construction of a small-spaced slanted light outgoing section with a small number of parts. The photo diode 26 mounted on the substrate 29 with the flexible cable together with the preamplifier 27 is of a backside incidence-type structure, and is mounted on the substrate 29 with the flexible cable face-down with flip-chip-bonding. The electrode and light receiving surface of the photo diode are coated with sealing resin 26a of the flip chip. This allows the penetration of moisture to be suppressed, and since the module dispenses with bonding wire, the high frequency characteristics of the receiving section optical system 2 are improved. In addition, in order to allow the received light reflected by the WDM filter 24 to be received from the backside of the photo diode 26, the substrate 29 with the flexible cable is fixed by Active Alignment Method, namely, after the position of the substrate 29 with the flexible cable is very accurately adjusted while observing the output with the operating conditions of the parts, it is fixed to the cutout 25 of the ferrule 23 with the resin.

Here, the LD can 11 with the adjusted optical axis is fixed to one end of the ferrule 23 by YAG (Y₃Al₅O₁₂) soldering, the other end of the ferrule 23 is polished, and the optical I/0 optical receptacle 3 is connected thereto so as to enable connection of an optical connector 5 shown later in FIG. 2. The circuit substrate 4 shown in FIG. 1B comprises flexible cable connectors 41 and 42, the afore-mentioned optically connected transmission section optical system 1, receiving section optical system 2 and optical I/O optical receptacle 3 are mechanically integrated and fixed to this circuit substrate 4, the flexible cable 13 is connected to the flexible cable connector 41, and the flexible cable 28 is connected to the flexible cable connector 42. The fixing and connection condition of the optical system to this circuit substrate 4 is shown in FIG. 2.

Described further in detail is the fixing and connection method shown in FIG. 2. An optical connector/adaptor 6 is fixed to the optical I/O optical receptacle 3 which is connected to the ferrule 23, and the optical connector/adaptor 6 is rigidly fixed on the circuit substrate 4, as well. The construction is that wherein stress is not applied between the transmission section optical system 1, the receiving section optical system 2 and the circuit substrate 4, by connecting the flexible cable 13 in the transmission section optical system 1 to the flexible cable connector 41 of the circuit substrate 4 and connecting the flexible cable 28 in the receiving section optical system 2 to the flexible cable connector 42 of the circuit substrate 4.

In addition, these connected units are fixed in the two places: fixing section A and fixing section B. The fixing section A is the region to which the optical I/O optical receptacle 3 is fixed, and since strong stress is applied at the time of attachment/detachment of the optical connector 5, it must be rigidly fixed in the direction of the optical axis in particular. At the same time, the fixing section B is for reinforcing the fixing strength of the combined units which can be hardly supported by only the fixing section A. The LD can 11 is fixed with a soft resin so that the longitudinal optical transceiver module is able to endure strong vibrations and the like. This is because, if it is fixed with a hard resin, stress attributable to thermal expansion, warping of the substrate and the like is applied between the fixing section A and the fixing section B. In addition, the adoption of the fixing method such as this allows strong stress to the transmission section optical system 1 or to the receiving section optical system 2 at the time of attachment/detachment of the optical connector 5 to the optical connector/adaptor 6 to be suppressed.

Thus, according to the mode of the first embodiment, a structure to which an external stress is hardly applied is realized by spacing out and disposing the transmission section optical system 1, the receiving section optical system 2 and the optical I/O optical receptacle 3 in an almost straight line, and at the same time, the lateral width can be minimized, and a plurality of optical transceiver modules can be mounted at a high density. In addition, since the transmission section optical system 1 and the receiving section optical system 2 are spatially spaced out and, thereby, the flexible cable 13 and the flexible cable 28 are mutually spaced out, the electric talk becomes smaller and high-speed response can be realized.

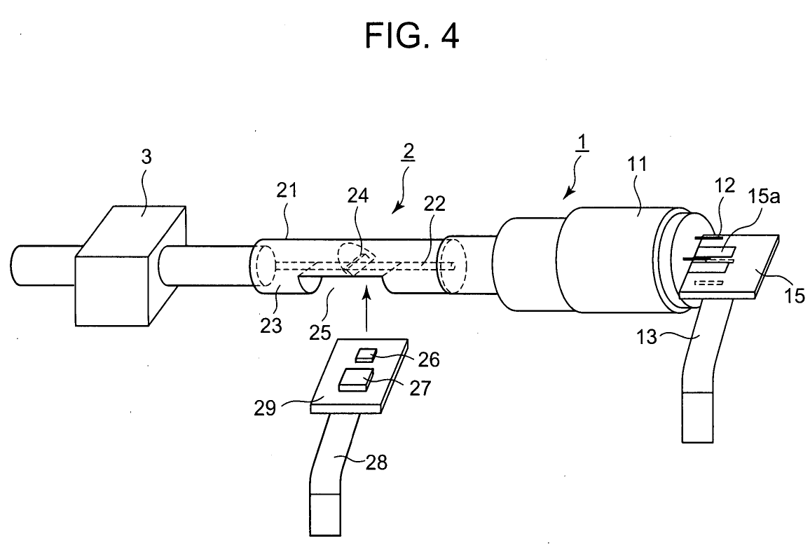

FIG. 4 is a perspective view showing the optical connection condition of the major elements in a second embodiment of the optical transceiver module according to the present invention. In this diagram, the same symbol is affixed and the description is omitted for the element which are the same in FIG. 1A and FIG. 1B. In comparison with the first embodiment, only the mounting structure of the substrate 15 with the LD flexible cable to the electric signal input lead wire 12 of the LD can 11 is different, and aside from this, this embodiment is constructed completely in the same constructions as the first embodiment. Mutually parallel electrodes 15a are formed on the front surface of the substrate 15 with the LD flexible cable shown here and also on the backside thereof as required, the electric signal input lead wires 12 are individually soldered to these electrodes, and furthermore, the flexible cables 13 are led in the vertical direction and in the horizontal direction to the electrodes 15a and are disposed in parallel with the flexible cable 28 of the receiving section optical system 2.

Thus, according to the second embodiment, the length of the signal input terminal to the transmission section optical system 1 can be minimized, and the high frequency characteristics can be enhanced. Furthermore, deviation in the rotational direction to the optical axis of the LD can 11 can be absorbed easily by arranging the leading direction of the electric signal input lead wire 12 of the LD can 11 and the extension direction of the signal line of the flexible cable 13 to be almost vertical. In addition, the substrate 15 with the LD flexible cable in the transmission section optical system 1 can be assembled so as to be parallel with the substrate 29 with the flexible cable in the receiving section optical system 2, and thereby, the mounting of the optically connected optical module on the circuit substrate 4 can be facilitated, and the length of the substrate in the direction of the optical axis can be minimized.

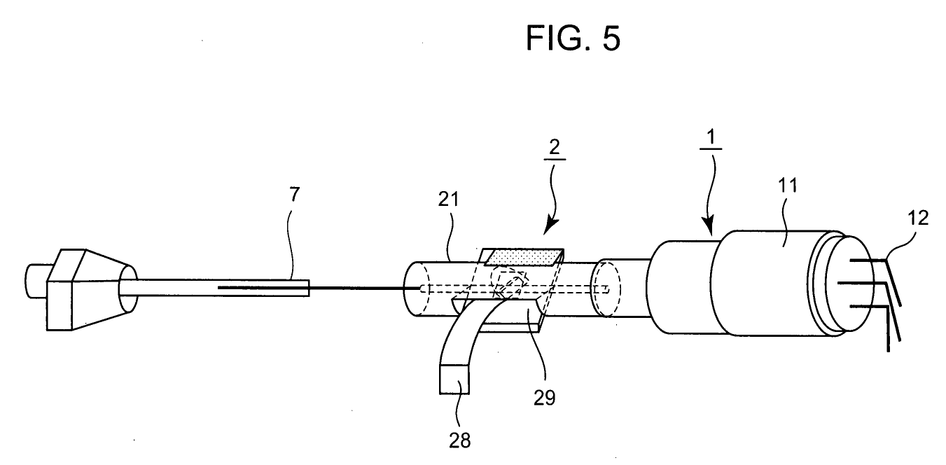

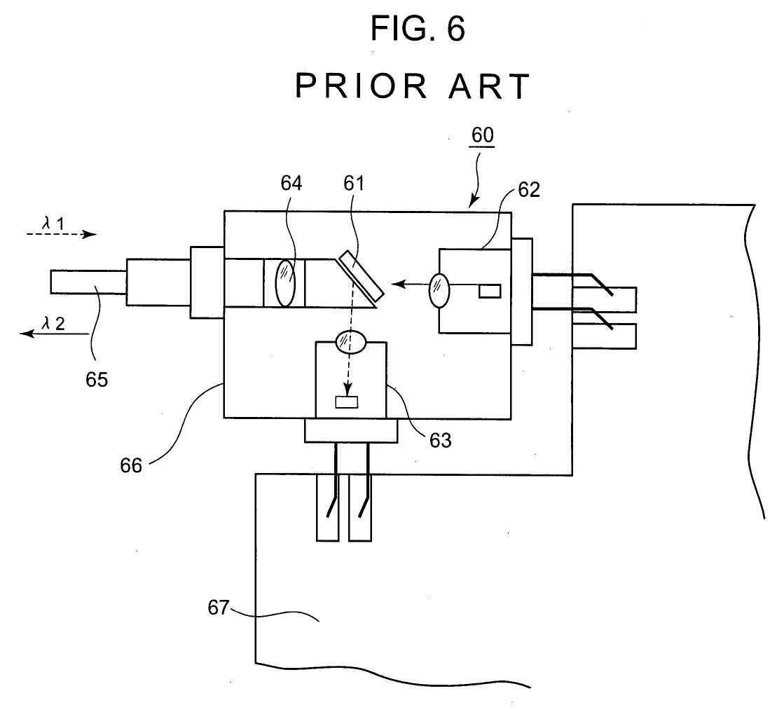

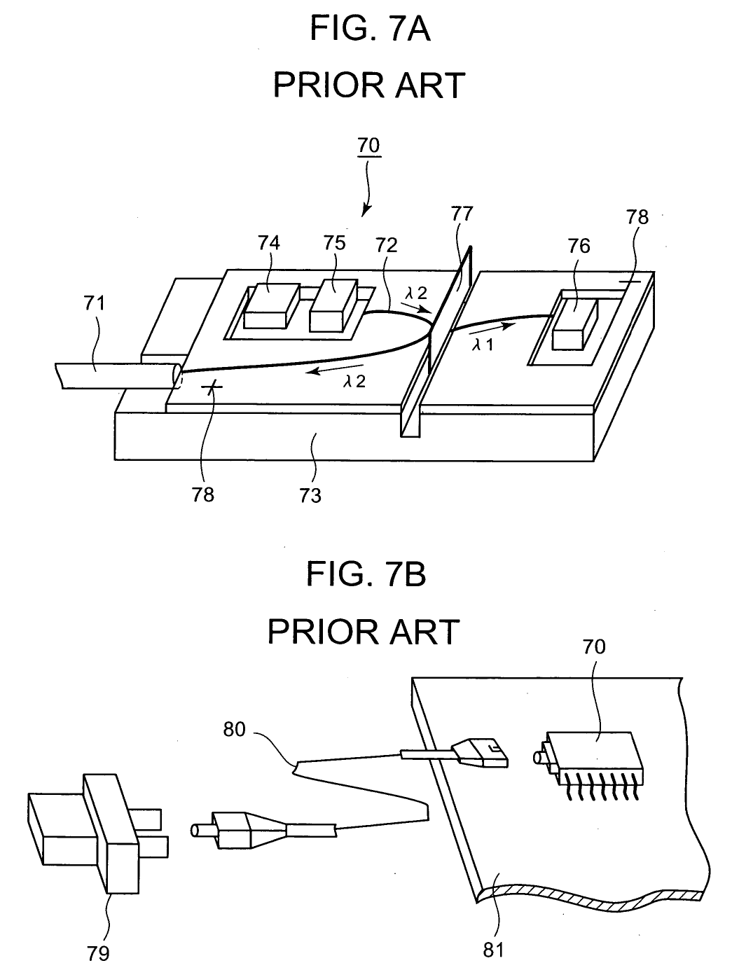

FIG. 5 is a perspective view showing the construction in a third embodiment of the optical transceiver module according to the present invention. In this embodiment, the afore-mentioned LD can 11 is determined to be the transmission section optical system 1, one end of the optical fiber 21 in the afore-mentioned receiving section optical system 2 is connected to the transmission section optical system 1, the optical fiber pig tail is connected to the other end of the optical fiber 21, and the pig tail-type fiber pig tail 7 is connected, to construct the optical transceiver module.

According this third embodiment, stress applied at the time of attachment/detachment of the optical connector will cease to affect the transmission section optical system 1 and the receiving section optical system 2. In addition, when the transmission section optical system 1 and the receiving section optical system 2 are simultaneously fixed rigidly to the circuit substrate or the like, the generation of any stress between them can be avoided by replacing the electric signal input terminal of the receiving section optical system 2 with the flexible cable 28.

Although the transmission section optical system 2, wherein the WDM filter 24 is mounted on the optical fiber 21 to form the slanted light outgoing section, is used in each afore-mentioned embodiment, the same effect as in the foregoing can be obtained by constructing the transmission section optical system 2 by using the optical waveguide in place of the optical fiber 21, as well.

In addition, although, the WDM filter 24 is mounted between the processed surfaces of the core 22 in the optical fiber in each afore-mentioned embodiment, a half mirror can also be used in place of the WDM filter 24.

### INDUSTRIAL APPLICABILITY

As is clear from the foregoing descriptions that, according to the present invention, since the construction is that wherein a transmission section optical system, a receiving section optical system, and a optical I/O optical receptacle are optically connected, mechanically integrated and fixed, and two flexible cables are spatially spaced out and disposed, a small-sized receptacle structure optical transceiver module wherein any stress attributable to the difference in coefficient of thermal expansion between these systems and the components which integrate and fix them is not applied therebetween, and which is not influenced by any stress at the time of attachment/detachment of the optical connector can be provided, and therefore, the present invention is useful in the optical communication field and the like.

1. An optical transceiver module, wherein a transmission section optical system which comprises a laser diode and an optical fiber or an optical waveguide optically connected to said laser diode and of which an electrical input terminal of said laser diode is a flexible cable, a receiving section optical system which comprises a photo diode and an optical fiber or an optical waveguide optically connected to said photo diode and of which an electric output terminal is a flexible cable, and an optical I/0 optical receptacle are optically connected, mechanically integrated and fixed, and said two flexible cables are spatially spaced out and disposed.

2. An optical transceiver module according to claim 1, wherein said transmission section optical system, said receiving section optical system and said optical I/O output receptacle are disposed in an almost straight line.

3. An optical transceiver module according to claim 2, wherein: said transmission section optical system comprises an optical fiber having processed surfaces which traverse a core on a slant and are opposite to each other in-line in the longitudinal direction, a slanted light outgoing section formed by inserting a filter or a half mirror between said processed surfaces, and a photo diode which is optically connected to said slanted light outgoing section; said transmission section optical system is connected to one end of said optical fiber; and said optical I/O optical receptacle is connected to the other end of said optical fiber.

4. An optical transceiver module according to claim 3, wherein said photo diode has a backside incidence-type structure wherein light is entered from a surface opposite to an electrode surface having positive and negative electrodes, and said photo diode is flip-chipped on a circuit substrate to which the flexible cable is connected.

5. An optical transceiver module according to claim 1, wherein: said transmission section optical system has an airtight can package from which an electric signal input lead wire is led; said electric signal input lead wire and a flexible cable or the electrode surface of a flexible cable with a substrate are disposed in parallel; and said electric signal input lead wire and said flexible cable or the electrode of the flexible cable with the substrate are connected.

6. An optical transceiver module according to claim 5, wherein the leading direction of the electric signal input lead wire in said airtight can package and the extension direction of the signal line in said flexible cable are almost vertical.

7. An optical transceiver module with a pig-tail fiber, wherein: a transmission section optical system which comprises a laser diode and an optical fiber or an optical waveguide optically connected to said laser diode and a receiving section optical system which includes a photo diode and an optical fiber or an optical waveguide optically connected to said photo diode are optically connected, mechanically integrated and fixed; and one of the electric input terminal in said transmission section optical system or the electric output terminal in said receiving section optical system is a flexible cable.
